(19) United States
(12) Patent Application Publication
(10) Pub. No.: US 2015/0196786 A1
(43) Pub. Date: Jul. 16, 2015

(54) PORTABLE FIRE DRILL TRAINING APPARATUS

(71) Applicants: Ron Church, Silverton, OR (US); Charles R. Pratt, II, Fairview, OR (US)

(72) Inventors: Ron Church, Silverton, OR (US); Charles R. Pratt, II, Fairview, OR (US)

(73) Assignee: OREGON HEALTH AND SCIENCE UNIVERSITY, Portland, OR (US)

(21) Appl. No.: 14/154,461

(22) Filed: Jan. 14, 2014

(51) Int. Cl. A62C 99/00

(52) U.S. Cl. CPC A62C 99/0081

(57) ABSTRACT

Portable fire drill training apparatuses which mimic an actual building install of a fire alarm system for training in localized areas are disclosed. In one example approach, a portable fire drill training apparatus is described which lacks any heat, smoke, or fire detectors and comprises an enclosure, a fire alarm notification appliance mounted on the enclosure, and a manual fire alarm activation device with an actuation element, where the manual fire alarm activation device is mounted on the enclosure and is configured to activate the fire alarm notification appliance in response to a user engaging the actuation element.

### TECHNICAL FIELD

The present disclosure relates to the field of fire drill training devices.

### BACKGROUND

Fire drill training may be periodically performed in buildings to simulate emergency conditions in order to practice, assess, and improve emergency protocols, such as building evacuation protocols, response to alarms, fire plans, fire safety codes, etc. Additionally, jurisdictions may require that fire drills be conducted at certain intervals in schools, universities, and hospitals, for example.

Fire drill training may be performed in a variety of ways. As an example, an emergency alarm system, e.g., one or more fire alarm appliances installed throughout a building or campus may be manually activated, e.g., via an actuation element on a manual fire alarm activation device such as a manual pull station or manual call point, to simulating emergency conditions. This may provide training on how to use a manual fire alarm activation device installed in a building and what to expect and/or how to react after an alarm system is activated. After the alarm system is activated, safety protocols may then be practiced and assessed under the simulated alarm conditions. For example, a building or area may be evacuated as though a real fire had occurred, the time it takes to evacuate may be measured to ensure that it occurs within a reasonable length of time, and problems with the emergency system or evacuation procedures may be identified to be remedied. After the fire drill is complete, the alarm system may be deactivated.

The inventors herein have recognized that, in certain situations, fire drill training may be disruptive to those who are not undergoing the fire drill training. For example, when performing a fire alarm drill in a building or on a campus, such as a hospital or university, activation of a fire alarm system may cause the alarms to be activated throughout the entire building or campus, thus impacting and potentially disturbing operations of others in the building or on the campus. For example, in a hospital setting, such a fire drill may disrupt doctors, faculty, patients, students, and/or other personnel who are not participating in the training. It therefore may be desirable to limit the fire drill training to a certain area of the building or campus so that other areas are not affected by the training.

### SUMMARY

The present disclosure is directed to portable fire drill training apparatuses which mimic an actual building install of a fire alarm system for training in localized areas. In one example approach, a portable fire drill training apparatus is described which lacks any heat, smoke, or fire detectors and comprises an enclosure, a fire alarm notification appliance mounted on the enclosure, and a manual fire alarm activation device with an actuation element, where the manual fire alarm activation device is mounted on the enclosure and is configured to activate the fire alarm notification appliance in response to a user engaging the actuation element.

Such an approach provides a self-contained portable fire drill training device which mimics an actual building installation of a fire alarm system by including both a fire alarm notification appliance and a manual fire alarm activation device mounted on the same portable unit as they would appear on a wall in a building, for example. Such a portable fire drill training apparatus may be brought into and positioned in a specified area in a building or on a campus so that performance of a fire drill may be localized to that specific area thereby reducing impact on and disruption of other areas of the building or campus.

Such a portable fire drill training apparatus may be used to provide training on how to use a manual fire alarm activation device installed in a building and what to expect and/or how to react after an alarm system is activated. For example, the training apparatus may be brought to a specific room in a building and used to provide training localized to that room of the building thereby reducing impact on others in the building which are not undergoing the fire drill training. Such an apparatus may be compact, portable, and may have the ability to be plugged in and/or run on batteries included in the device. Further, by not including any detectors or sensors, such as heat, smoke or fire detectors, in the training device, costs may be reduced and detection regulations may be avoided since the device is only used for training purposes and not for actual fire, smoke, or heat detection.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic depiction of an example portable fire drill training apparatus in accordance with the disclosure.

FIG. 2 shows a schematic depiction of an example manual fire alarm activation device.

FIG. 3 shows a perspective view of an example portable fire drill training apparatus in accordance with the disclosure.

### DETAILED DESCRIPTION

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

The description may use the terms “embodiment” or “embodiments,” which may each refer to one or more of the same or different embodiments. Furthermore, the terms “comprising,” “including,” “having,” and the like, as used with respect to embodiments, are synonymous.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

As remarked above, fire drill training may be periodically performed in buildings to simulate emergency conditions in order to practice, assess, and improve emergency protocols, such as building evacuation protocols, response to alarms, fire plans, fire safety codes, etc. However, fire drill training may be disruptive to those who are not undergoing the fire drill training. For example, when performing a fire alarm drill in a building or on a campus, such as a hospital or university, activation of a fire alarm system may cause the alarms to be activated throughout the entire building or campus, thus impacting and potentially disturbing operations of others in the building or on the campus. Thus, it may be desirable to limit the fire drill training to a certain area of the building or campus so that other areas are not affected by the training. In view of these issues, embodiments directed to portable fire drill training apparatus which mimics an actual building install of a fire alarm system for training in localized areas of a building are described.

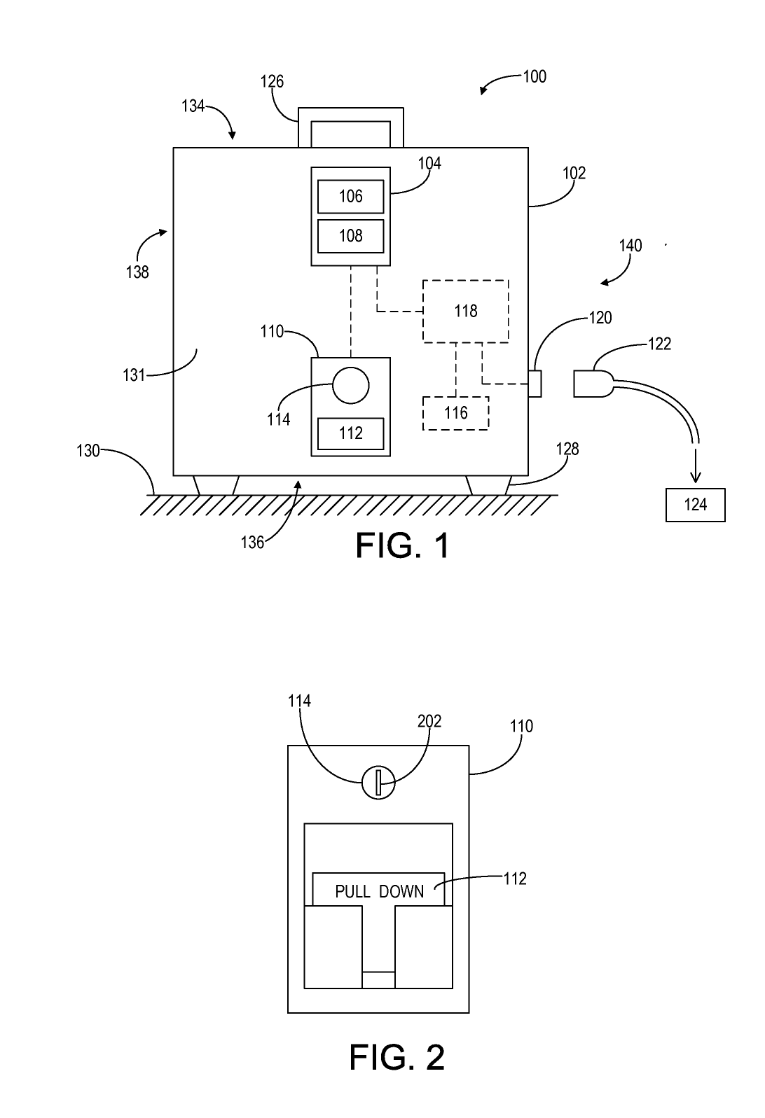

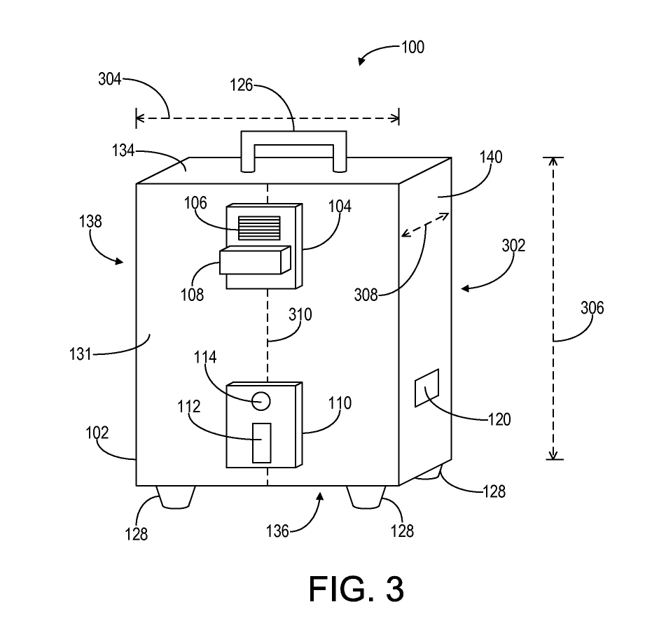

Turning to the figures, FIG. 1 shows a schematic depiction of an example portable fire drill training apparatus 100, FIG. 2 shows schematic depiction of an example manual fire alarm activation device 110 which may be included on the fire drill training apparatus, and FIG. 3 shows a perspective view of an example portable fire drill training apparatus 100. FIGS. 1-3 are described concurrently in the following description where like-numbered elements shown in FIGS. 1-3 refer to the same or a substantially similar element.

Portable fire drill training apparatus 100 comprises an enclosure 102 which includes a front face 131, a back face 302 opposing front face 131, a top surface 134, a bottom surface 136 opposing top surface 134, and two opposing sides/surfaces 140 and 138 that form a box-shaped unit. Various components, examples of which are described below, may be mounted onto exterior surfaces of the enclosure and included within an interior of the enclosure.

The enclosure 102 may be formed of any suitable material, e.g., one or more metals, plastics such as moulded acrylonitrile butadiene styrene (ABS) and/or polychlorinated biphenyls (PCBs), or combinations thereof. Further, enclosure 102 may have any suitable dimensions, e.g., any suitable length 304, width 308, and height 306. For example, the materials and dimensions used in manufacturing apparatus 100 may be selected to reduce the weight and size of the apparatus in order to increase portability of the apparatus. In some examples, the height 306 and length 304 may both be greater than, e.g., at least twice as long as, the width 308 of the device. For example, the height 306 and length 304 may be approximately 30 centimeters whereas the width 308 may be approximately 13 centimeters. However, it should be understood that any suitable dimensions may be used.

In some examples, the portable fire drill training apparatus 100 may not include any sensors or detector elements. For example, the apparatus 100 may lack any heat, smoke, or fire detectors or sensors. However, in some examples, the portable fire drill training apparatus 100 may not include any functional sensors or detectors, e.g., the apparatus 100 may lack any functional heat, fire or smoke detectors or sensors. In particular, in some examples, apparatus 100 may include at least one sensor or detector, but the detectors or sensors included in the apparatus may not be functional or may be disabled so that the apparatus is only used as a training device and is not capable of being used as a heat, smoke, or fire detection device. By not including any detectors or sensors, such as heat, smoke or fire detectors, in the training device, costs associated with including such sensors or detectors may be avoided thereby potentially reducing the manufacturing costs of the device. Further, by not including any functional sensors or detectors in the device, regulations or standards associated with fire, smoke, or heat detection devices may be avoided thereby potentially reducing costs associated with obtaining regulatory approval to meet any standards required for fire, smoke, or heat detection devices.

Apparatus 100 mimics an actual building installation of fire alarm system components thus includes a fire alarm notification appliance 104 mounted on the enclosure 102. For example, the fire alarm notification appliance 104 may be mounted on the front face 131 of the enclosure in order to mimic a fire alarm notification appliance mounted on a surface such as a wall in a building. The fire alarm notification appliance 104 may be mounted in any suitable way to the front face 131 of enclosure 102. For example, the fire alarm notification appliance 104 may be configured to be installed onto a surface such as a wall and may be mounted in a similar manner to the front face of the enclosure. For example, the fire alarm notification appliance 104 may be bolted to the front face 131 of the enclosure. In some examples, a portion of the fire alarm notification appliance 104 may extend into an interior of the enclosure via an aperture in the enclosure. For example, the fire alarm notification appliance 104 may include a speaker which extends from a back side of the fire alarm notification appliance 104 into an interior of the enclosure.

The fire alarm notification appliance 104 may comprise any suitable device which utilizes audible, visible, tactile, textual or even olfactory stimuli (odorizer) to provide a notification of an emergency event such as a fire. For example, fire alarm notification appliance 104 may include one or more speakers 106 so that the fire alarm notification appliance is configured to emit sounds from the one or more speakers 106 in response to an activation of the fire alarm notification appliance 104. As another example, the fire alarm notification appliance 104 may include one or more light sources 108 so that the fire alarm notification appliance 104 is configured to emit light from the one or more light sources 108 in response to an activation of the fire alarm notification appliance 104. In some examples, the one or more light sources 108 may comprise strobe lights, e.g., clear, high-intensity strobes.

Apparatus 100 also includes a manual fire alarm activation device 110. The manual fire alarm activation device 110 may comprise any suitable manually actuated element configured to activate the fire alarm notification appliance 104 in response to receiving input from a user. For example, the manual fire alarm activation device 110 may be a fire alarm box, a manual pull station, a break glass station, a call point, a button, a switch, etc. Manual fire alarm activation device 110 is mounted on the front face 131 of enclosure 102 in order to mimic a fire alarm activation device installation on a surface or a wall, e.g., on a wall in a building. The position of the manual fire alarm activation device 110 along the front face 131 may be selected to mimic the positioning of an activation device relative to a fire alarm appliance as installed in a building. For example, the manual fire alarm activation device 110 may be mounted on the front face 131 of the enclosure at a position directly below the fire alarm notification appliance 104 along a central axis 310 of the front face 131 as shown in FIG. 3.

The manual fire alarm activation device 110 may include an actuation element 112 so that the device 110 is configured to activate the fire alarm notification appliance 104 in response to a user engaging the actuation element 112. The manual fire alarm activation device 110 and the actuation element 112 may take any suitable form. For example, as shown in FIG. 2, the manual fire alarm activation device 110 may be a manual fire pull station where the actuation element 112 is a T-bar pull with a handle shaped like the letter “T.” In this example, a user may activate the fire alarm notification appliance 104 by pulling the handle 112 down, which completes a circuit and locks the handle in an activated position. In some examples, the manual pull station 110 shown in FIG. 2 may require two hand motions, such as lift up and pull down, or push in and pull down in order to activate the fire alarm notification appliance. As another example, the manual fire alarm activation device 110 may be a manual call point (MCP) and the actuation element 112 may be a push button or similar element. For example, under normal conditions the push button may be in a depressed condition but may be released when a user presses the button via a spring action which actuates the fire alarm notification appliance 104.

Apparatus 100 also includes a power source 116 in electrical communication with the fire alarm notification appliance and configured to provide electrical power to various components of apparatus 100. The power source may be any suitable source of electricity used to power the notification appliance 104 and may be an internal power source located or mounted within enclosure 102 or an external power source. For example, a power supply line 122 may be used to couple the apparatus to an external power supply 124. In some examples, the power source 116 may comprises one or more batteries included within the enclosure 102. The one or more batteries may be rechargeable batteries such as lead-acid, nickel cadmium (NiCd), nickel metal hydride (NiMH), lithium ion (Li-ion), or lithium ion polymer (Li-ion polymer) batteries. For example, one or more rechargeable batteries 116 may be mounted within an interior of the enclosure 102 and may be in electrical communication with the fire alarm notification appliance 104 and the manual fire alarm activation device 110.

The apparatus may also include a port 120 coupled to the one or more batteries 116, where the port is configured to receive an external power supply line 122 which is coupled to an external power supply 124 such as a wall outlet. In some examples, apparatus 100 may further include a power distribution module 118 coupled to the power source 116 and the fire alarm notification appliance 104. Power distribution module 118 may be mounted within enclosure 102, e.g., coupled to an interior surface of enclosure 102, and may be configured to convert AC or DC inputs into individually fuse protected outputs to distribute power to various components of apparatus 100.

Apparatus 100 may additionally include a reset or deactuation element 114. The deactuation element 114 is configured to deactivate the fire alarm notification appliance 104 in response to a user engaging the deactuation element 114. The deactuation element 114 may be coupled to apparatus 100 in any suitable location. In one example, the deactuation element 114 may be included in the manual fire alarm activation device 110 as shown in the figures. The deactuation element 114 may comprise any suitable features or elements which receive user input to deactivate or reset the fire drill training device, e.g., to turn off the notification appliance 104 after a fire drill training session is complete. For example, as shown in FIG. 2, the deactuation element 114 may be a slot 202 configured to receive a key or other suitable tool so that, in response to a user engaging the deactuation element 114 via an insertion of the key or tool into the slot 202, operation of the fire alarm notification appliance 104 is discontinued. Other examples of deactuation element 114 include a button, a switch, a microphone configured to receive voice command input, a power switch, etc.

As remarked above, apparatus 100 is a self-contained, portable unit thus may include various elements and features designed to assist in moving the device from place to place, positioning the device at different locations, storing the device, etc. For example, apparatus 100 may include a handle 126 or other similar elements mounted to one or more surfaces of apparatus 100, e.g., mounted to top surface 134 of the enclosure 102, so that the device may be easily carried from place to place. As another example, apparatus 100 may include one or more foot elements 128 mounted to a bottom surface 136 of the enclosure 102. The foot elements may interface with a surface 130 such as a table, a floor, a desk, the ground, etc., and may be used to provide support and stabilize the device during use. Apparatus 100 may include any suitable type and number of foot elements, e.g., four foot elements along the bottom surface 136. For example, the foot elements 128 may be composed of a plastic or rubber material to provide traction to assist in stability. In some examples, one or more wheels or rollers may be coupled to apparatus 100 adjacent to bottom surface 138 or other suitable location to assist in mobility of the device.

An example use case of apparatus 100 is described in the following. Fire drill training personnel may identify a certain area of a building or campus where fire drill training is to be performed. Apparatus 100 may then be brought into the area, e.g., into a room or other space, and placed on a table or floor or mounted on a wall or other surface in order to mimic the actual manual fire alarm activation devices and notification appliances installed throughout the building or campus. A user may then practice actuating a fire alarm by engaging the actuation element on the manual fire alarm activation device on the portable apparatus 100 which causes the notification appliance on the apparatus 100 to become activated and emit sounds and/or light in a manner similar to when a real fire or emergency condition occurs in the building or on the campus. While the notification device is activated, response protocols may be rehearsed for training and assessment purposes. After the fire drill training is complete, a user may deactivate the apparatus by providing input to the deactuation element 114.

It is to be understood that the configurations and/or approaches described herein are exemplary in nature, and that these specific embodiments or examples are not to be considered in a limiting sense, because numerous variations are possible. The subject matter of the present disclosure includes all novel and nonobvious combinations and subcombinations of the various apparatuses, systems and configurations, and other features, functions, acts, and/or properties disclosed herein, as well as any and all equivalents thereof.

1. A portable fire drill training apparatus, comprising:
an enclosure;
a fire alarm notification appliance mounted on the enclosure;
a manual fire alarm activation device comprising an actuation element, the manual fire alarm activation device mounted on the enclosure and configured to activate the fire alarm notification appliance in response to a user engaging the actuation element; and
wherein the portable fire drill training device lacks any heat, smoke, or fire detectors.

2. The apparatus of claim 1, wherein the manual fire alarm activation device is a manual fire pull station and the actuation element is a T-bar.

3. The apparatus of claim 1, wherein the manual fire alarm activation device is a manual call point and the actuation element is a push button.

4. The apparatus of claim 1, further comprising a power source coupled to the fire alarm notification appliance.

5. The apparatus of claim 4, wherein the power source comprises one or more batteries included within the enclosure.

6. The apparatus of claim 5, wherein the one or more batteries are rechargeable batteries and the apparatus further comprises a port coupled to the one or more batteries, where the port is configured to receive an external power supply.

7. The apparatus of claim 4, further comprising a power distribution module coupled to the power source and the fire alarm notification appliance.

8. The apparatus of claim 1, wherein the fire alarm notification appliance comprises one or more speakers and wherein the fire alarm notification appliance is configured to emit sounds from the one or more speakers in response to an activation of the fire alarm notification appliance.

9. The apparatus of claim 1, wherein the fire alarm notification appliance comprises one or more light sources and wherein the fire alarm notification appliance is configured to emit light from the one or more light sources in response to an activation of the fire alarm notification appliance.

10. The apparatus of claim 9, wherein the one or more light sources comprise strobe lights.

11. The apparatus of claim 1, wherein the fire alarm notification appliance is mounted on a front face of the enclosure and wherein the manual fire alarm activation device is mounted on the front face of the enclosure at a position below the fire alarm notification appliance.

12. The apparatus of claim 1, further comprising a deactuation element, wherein the deactuation element is configured to deactivate the fire alarm notification appliance in response to a user engaging the deactuation element.

13. The apparatus of claim 12, wherein the deactuation element is included in the manual fire alarm activation device.

14. The apparatus of claim 12, wherein the deactuation element comprises a slot configured to receive a key, wherein the deactuation element is configured to deactivate the fire alarm notification appliance in response to a user engaging the deactuation element via an insertion of a key into the slot.

15. The apparatus of claim 1, further comprising a handle mounted to a top surface of the enclosure.

16. The apparatus of claim 1, further comprising one or more foot elements mounted to a bottom surface of the enclosure.

17. A portable fire drill training apparatus, comprising:
an enclosure with opposing front and back faces and opposing top and bottom surfaces;
a fire alarm notification appliance mounted on the front face of the enclosure;
a manual fire alarm activation device comprising an actuation element, the manual fire alarm activation device mounted on the front face of the enclosure directly below the fire alarm notification appliance along a central axis of the front face, where the manual fire alarm activation device is configured to activate the fire alarm notification appliance in response to a user engaging the actuation element; and
one or more rechargeable batteries within an interior of the enclosure, the one or more rechargeable batteries in electrical communication with the fire alarm notification appliance and the manual fire alarm activation device;
wherein the portable fire drill training device lacks any functional heat, smoke, or fire detectors.

18. The apparatus of claim 17, further comprising a deactuation element, wherein the deactuation element is configured to deactivate the fire alarm notification appliance in response to a user engaging the deactuation element.

19. The apparatus of claim 17, further comprising a handle mounted to the top surface of the enclosure.

20. The apparatus of claim 17, further comprising one or more foot elements mounted to the bottom surface of the enclosure.
